(19) United States
(12) Patent Application Publication
(10) Pub. No.: US 2008/0014567 A1
(43) Pub. Date: Jan. 17, 2008

(54) Clinical healthcare education process and system using remote technologies

(76) Inventor: Loretta Schlachta-Fairchild, Frederick, MD (US)

Correspondence Address: NIXON PEABODY, LLP, 401 9TH STREET, NW, SUITE 900, WASHINGTON, DC, 20004-2128, US

(21) Appl. No.: 11/819,498

(22) Filed: Jun. 27, 2007

Related U.S. Application Data
(60) Provisional application No. 60/816,907, filed on Jun. 27, 2006.

(51) Int. Cl. G09B 19/00

(52) U.S. Cl. 434/262

(57) ABSTRACT

A process is disclosed for presenting clinical content and skills to clinical healthcare students using remote technology. The process may replace or enhance traditional hands-on clinical healthcare education using remote two-way technology. The process may, for example, allow clinical healthcare students to participate in clinical experience not available locally via a distant healthcare facility. The process may also allow students to experience increased access to interdisciplinary healthcare providers and their collaboration. The process provides a means by which expert healthcare preceptors may present clinical healthcare education and information to several students at the same time. The process may further present clinical experience in various languages, such as, for example, Spanish.

This application claims the benefit of U.S. Provisional Application No. 60/816,907, filed Jun. 27, 2007 which is incorporated herein in its entirety.

### STATEMENT REGARDING FEDERALLY SPONSORED RESEARCH OR DEVELOPMENT

This invention was made with Government support under Grant No. N00014-05-1-0825 and 0516 awarded by the Office of Naval Research. The Government may have certain rights in this invention.

### FIELD OF THE INVENTION

The present invention includes a method and system for utilizing remote technology as a new model for clinical education. More specifically, the invention relates to techniques for facilitating the clinical education of healthcare students by acquiring clinical skills, including, for example, critical thinking capability using remote technologies instead of or in addition to visiting actual clinical sites.

### BACKGROUND OF THE INVENTION

Clinical healthcare students, such as medical students, nursing students, physical therapy students, occupational therapy students, and other healthcare professionals seeking additional clinical skills and/or knowledge, apply theoretical concepts and develop critical analytical skills by observing professional clinical care of clinical patients. These students traditionally participate in and observe clinical learning experiences by physically visiting healthcare facilities. A deficiency of available clinical sites in healthcare facilities exists in many areas, especially in specialty areas like intensive care units and pediatric burn units because of the well-documented shortage of clinical healthcare providers available to act as preceptors. Many students who are enrolling in healthcare disciplines education have limited opportunities to participate in direct patient care due to a finite number of clinical learning sites at local hospitals and restricted access to specialty units at larger hospitals in distant cities.

Clinical healthcare instructors are responsible for coordinating, teaching and supervising clinical healthcare students during their clinical experiences. These instructional responsibilities entail locating healthcare facilities with clinical units willing to accommodate students and finding clinical healthcare providers willing to function as preceptors. The instructor may be an expert with a broad knowledge base and teaching experience, but is often not physically present with each student during their entire clinical experience. Instead, the clinical healthcare instructor must divide time and attention intermittently amongst the entire class of students at one or multiple healthcare facilities.

Additionally, the clinical healthcare instructor assumes liability for each unlicensed student in the class allowing them to participate in the clinical experience under the auspices of the instructor's state licensure. The clinical healthcare preceptor at the healthcare facility, who has an unlicensed student working alongside him or her, shares responsibility for the student when the clinical instructor is not present. Currently, there is a shortage of clinical healthcare instructors and clinical healthcare preceptors willing to take on this burden.

The quality of the student's clinical learning experience is not only influenced by the availability of the clinical healthcare instructors, but also by the expertise of the preceptor and the availability of patients at the time of the clinical experience. The clinical healthcare preceptor functions in two capacities when a clinical healthcare student is participating in the care of a patient. First, the preceptor is required to provide the best possible care to the patient. Second, the preceptor disseminates knowledge about the clinical aspects of the patient care to the student. The preceptor's attention at times may be divided between the patient and the student. Furthermore, each clinical healthcare preceptor has a varying degree of experience and teaching background, sometimes resulting in inconsistent quality of patient care content presented to the student.

Thus a need exists in the art for additional opportunities for clinical healthcare students to participate in clinical education experiences that will allow for more and/or better clinical training. Alternative clinical training approaches such as simulation are growing in acceptance; however, they do not provide a real-time, live clinical experience for the student. A need exists for a methodology capable of providing clinical education opportunities to clinical healthcare students utilizing remote technologies instead of or in addition to visiting physical clinical sites.

### SUMMARY OF THE INVENTION

An object of the invention is to provide a process for healthcare professionals to present clinical content and skills to clinical healthcare students, in a consistent and highly effective manner, whereby students are assured of meeting predetermined learning objectives by providing remote technology for clinical education. This content may also be presented in a standardized fashion using a variety of clinical experiences, without geographic or resource constraints and with a more effective faculty-to-student ratio.

The present invention provides for a process for utilizing remote technology as a new model for clinical education within the clinical healthcare curriculum for clinical healthcare education. One embodiment of the present invention provides a method and/or system for replacing or enhancing traditional hands-on clinical healthcare education with student participation in virtual clinical healthcare education via remote two-way technology. Additionally, the student may communicate directly with the healthcare providers and potentially with patients in real-time as if they were physically in the same location. The student may also use remote diagnostic tools such as a digital stethoscope, digital ophthalmoscope and other devices as desired that can transmit remote physical, pathological, or radiological assessments and/or vital signs. In another aspect of an embodiment of the present invention, the content of instruction may provide assurance of meeting predetermined learning objective(s).

In another aspect of an embodiment of the present invention, a method and/or system for clinical healthcare students to participate in clinical experience not available in local healthcare facilities may be provided. For example, healthcare students may observe the care of a patient with complex health issues in a distant healthcare facility. In this regard, the embodiment of the invention provided for herein may save time, fuel, and other resources because the healthcare students do not need to travel in order to participate in the clinical experience. Further, certain embodiments of the present invention facilitate the combination of resources otherwise not present in a single location.

In another embodiment of the present invention, clinical healthcare students may be provided a system or method offering greater access to interdisciplinary healthcare providers and their collaboration. A healthcare student may learn multiple aspects of care from several different types of healthcare professionals in a single experience. Examples of interdisciplinary healthcare providers may include but are not limited to nurses, physical therapists, physician assistants, wound care specialists, pathologists, radiologists, and psychiatric clinicians who all may interact with the patient, the clinical preceptor and/or the learners. The interaction may be live, real-time and may include two-way audio and video as if all participants were in the same room or general location together.

In accordance with another aspect of an embodiment of the present invention, a method for helping interdisciplinary healthcare students develop critical thinking skills is provided by using tailored learning modules containing superior clinical content.

In yet another embodiment of the present invention, healthcare information or clinical experiences may be presented in various languages such as, for example, the Spanish language.

In another implementation of an embodiment of the present invention, a method for ensuring a safe patient care environment during a clinical practicum is provided by having two expert clinical preceptors providing healthcare information to students. One professional may focus on delivering the care to the patient, while the other professional may provide one of more of the following, including: narrating the actions, decisions being made, and rationale, challenging the students with questions, and answering students' questions.

In another aspect of an embodiment of the present invention, a method is provided for expert healthcare preceptors to present clinical healthcare information about patients with complex problems to several nursing students at the same time, or to groups of nursing or other healthcare clinical students in various schools nationally and/or worldwide at the same time in one or more languages.

One unexpected benefit of the present invention is that the students like the experience and learn better in part by being able to learn in a familiar environment without distractions provided by controlled stimulus and focused instruction. Students also appreciate both broadened and more thorough clinical learning by having access to multiple specialty care fields not otherwise available to students due to geographic limitations or other factors.

An additional unexpected benefit of the present invention is that the virtual clinical experience solves the long-felt problem of faculty shortage in the nursing and medical fields. Many students across the country may be addressed by a single faculty member, thereby increasing the number of students that may taught at a given time and meeting the high demand for nurses in the field.

### BRIEF DESCRIPTION OF THE DRAWINGS

Illustrative and presently preferred embodiments of the invention are shown in the accompanying drawings which are intended to illustrate and not to limit the invention as follows:

FIGS. 1A and 1B are diagrams illustrating embodiments of the present invention depicting the distribution of the patient, students and interface-enabling network or equivalent systems;

FIG. 2 is a flowchart illustrating a method of an embodiment of the present invention;

FIG. 3 is a diagram illustrating the equipment enabling an embodiment of the invention; and

FIG. 4 is a flowchart illustrating another method of an embodiment of the present invention.

### DETAILED DESCRIPTION OF THE INVENTION

It should be understood that this invention is not limited to the particular methodology, protocols, etc., described herein and, as such, may vary. The terminology used herein is for the purpose of describing particular embodiments only, and is not intended to limit the scope of the present invention, which is defined solely by the claims.

As used herein and in the claims, the singular forms “a,” “an,” and “the” include the plural reference unless the context clearly indicates otherwise. Thus, for example, a reference to a healthcare student may be a reference to one or more such healthcare student(s), including equivalents thereof known to those skilled in the art unless the context of the reference clearly dictates otherwise.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

Unless defined otherwise, all technical terms used herein have the same meaning as those commonly understood to one of ordinary skill in the art to which this invention pertains. Although any known methods, devices, and materials may be used in the practice or testing of the invention, the preferred methods, devices, and materials in this regard are described here.

Healthcare student includes, for example, any student in any healthcare discipline. An example may include, but is not limited to, students in nursing, physical therapy, medicine, radiology, pathology, and physician assistants. Clinical content of healthcare information refers, for example, to the use of specific healthcare educational content, care, treatments, therapies and medications for a patient. Specific examples may include, but are not limited, to wound care, allowing more efficient instruction of healthcare students about care of patients with burns.

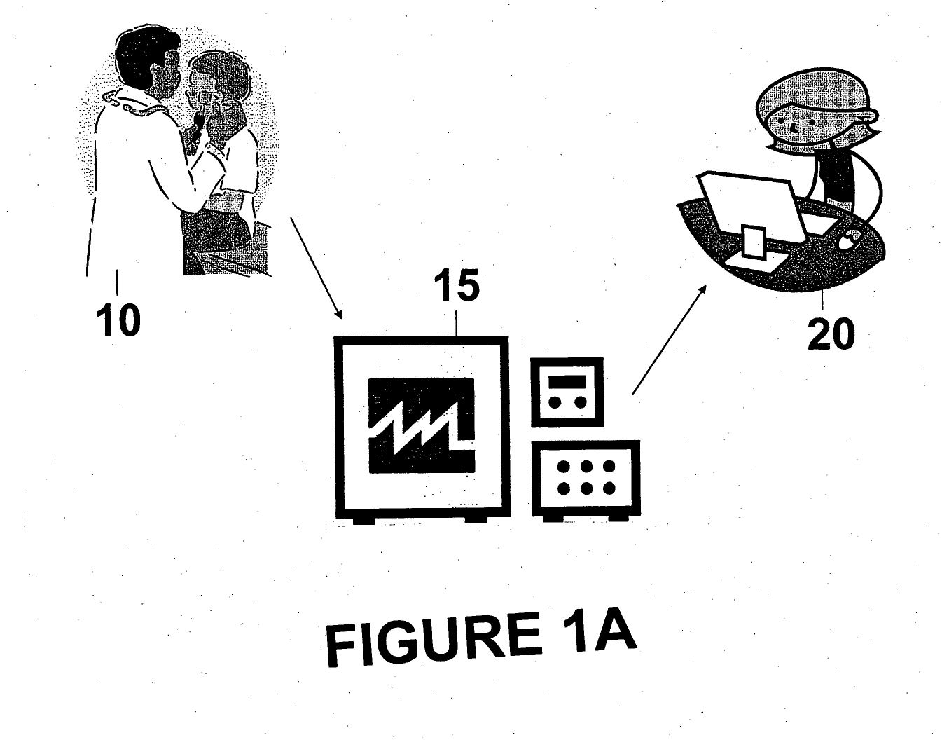

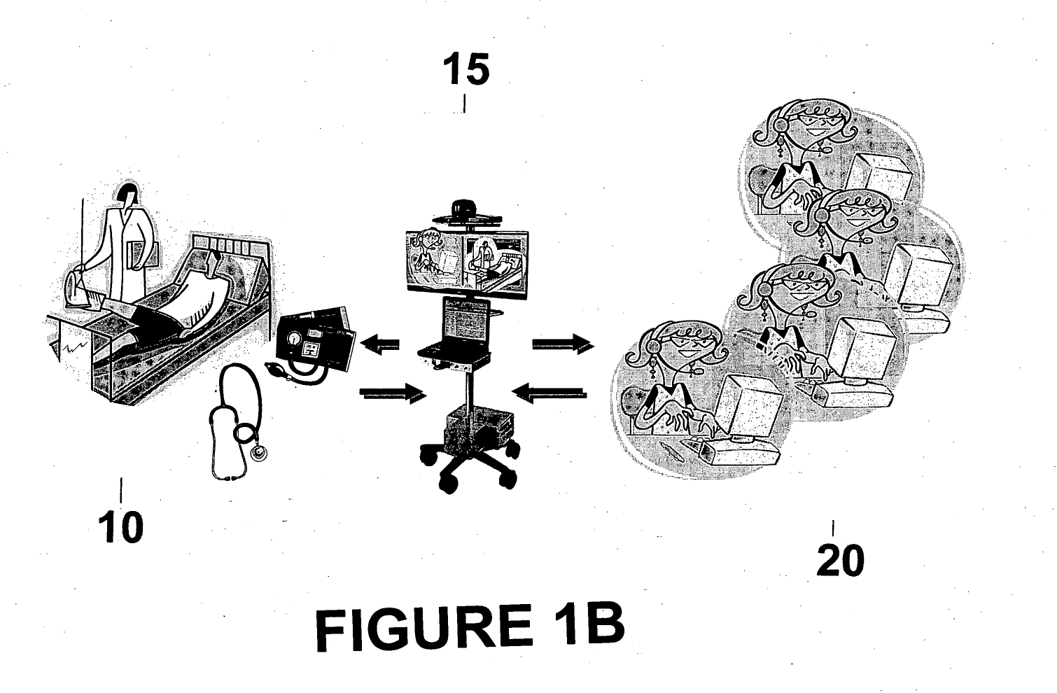

Referring now to the drawings wherein the showings are for purposes of illustrating a preferred embodiment of the present invention only and not for purposes of limiting the same, FIG. 1 provides for a method that replaces and/or enhances traditional hands-on clinical healthcare educational experience with remote technology and/or remote physical assessment and diagnostic devices. An aspect of this invention allows healthcare students to hear and see healthcare providers and patients in real-time. An example may be, but not limited to, healthcare students actively participating in the clinical experience by asking questions and making comments to the healthcare provider and patient.

In FIGS. 1A and 1B, an expert healthcare provider 10 meets the learning objectives of learners. Information is exported, enabling a live, interactive exchange of clinical healthcare experience 15 to learners at various remote locations 20. The learners at various remote locations 20 may be several learners at a single remote location, or each learner may be at a separate remote location, or several learners may be at several remote locations.

It is contemplated that healthcare students staying within an educational facility may be remotely participating in a remote clinical experience presented at a separate location. In this embodiment, the healthcare students are not required to travel and thus may save resources, such as time and gas, and may have access to educational resources located in diverse venues. Additionally, the caliber of group discussion about a shared clinical experience may also result in improved learning, knowledge synthesis, and critical thinking.

In accordance with another implementation of an embodiment of the present invention, a method of delivering high quality and consistent levels of clinical content for healthcare students is provided. Specifically, the healthcare students may receive information unique to a patient with a rare diagnosis; for example, a patient with severe burns. The student may then observe treatments related to, for example, wound care and electrolyte resuscitation that they may not otherwise have the opportunity to observe.

According to another aspect of an embodiment of the present invention, a method for delivering multifaceted content delivered by interdisciplinary healthcare providers is contemplated. This clinical content presents various aspects of healthcare information unique to patients with a specific diagnosis; for example, an anesthesiologist teaching pain management and a physical therapist teaching range-of-motion exercises for a patient with severe burns.

It is also contemplated that healthcare students may develop critical thinking skills by using superior clinical content learning modules of an embodiment of the present invention. An example may include, but is not limited to, sample National Counsel Licensure Exam (NCLEX) questions for nursing students. An additional aspect of this method may include, but is not limited to, measurement of learning outcomes with web-enabled questionnaires.

It is contemplated that the methods of certain embodiments of the present invention may be implemented in English and/or a language other than English. For instance, the method may be implemented by a healthcare provider speaking Spanish. The remote educational experience may be presented in any language by automated or direct translation, text message, or otherwise to students or healthcare professionals seeking additional learning anywhere in the world.

Furthermore, the embodiments of the present invention are not limited to a given healthcare or medical specialty. The healthcare student may participate in a virtual training program for a patient with any diagnosis.

According to another embodiment of the present invention, a method is provided for ensuring a safe patient care environment during remote clinical experience by having two healthcare professional preceptors providing healthcare information. An example may be, but is not limited to, one healthcare professional teaching aspects of clinical care and the other healthcare professional demonstrating patient care. The healthcare professional preceptor may be available to answer questions from students, and multiple professionals may provide support for patients or students 24 hours a day if desired and take advantage of multiple time zones. A second healthcare professional may focus exclusively on the care and well-being of the patient

In accordance with another embodiment of the present invention, a method is contemplated by which healthcare information by a limited number of instructing healthcare providers is provided to several healthcare students, thus overcoming the shortage of healthcare instructors. An example may be, but is not limited to, a few healthcare professionals exchanging questions and comments in real-time with several healthcare students.

In yet another aspect of an embodiment of the current invention, an enhanced method of clinical instruction is contemplated that may allow healthcare students the opportunity to develop critical and analytical thinking skills by comparing a common experience during a post-virtual clinical session conference discussion. An example may be, but is not limited to, all or many of the students discussing one or more aspect(s) of care observed during a remote clinical experience.

According to another embodiment of the present invention, a method for designing and implementing a remote-location (virtual) clinical program is provided. The method may comprise the steps of identifying and selecting a participating student site; identifying clinical specialties to meet student learning objectives and/or learning needs (for example, burn care, intensive care, and pediatrics); selecting an appropriate clinical site, patient, and clinical specialists; obtaining permission from the patient, clinical specialists, and/or clinical site agreeing to participate; obtaining privacy/confidentiality agreements from some or all participants; selecting a network architecture that accommodates real-time two-way audiovisual and/or data communication; verifying secure network connectivity complying with HL7, HIPAA and/or any other mandatory technical and/or legal requirements; selecting hardware that transmits real-time two-way audiovisual- and/or data-enabling high-quality communication (for example, cameras, monitors, and lighting); testing network architecture connectivity, hardware and data transmission; identifying learning objectives of clinical experience and creating a tailored schedule based on these objectives which consists of, but is not limited to, interaction with multidisciplinary healthcare providers, live interactive voice and video with the patient and providers, and observation or virtual participation in patient procedures and therapies; ensuring that the faculty provide students with an assignment to prepare for “virtual clinical”; identifying appropriate dates and times to satisfy clinical learning objectives; obtaining relevant clinical information about selected patient(s) before scheduled remote learning experience (for example, history, medications, and laboratory results); removing all personally identifying information to ensure anonymity and transmitting such information to students prior to the remote clinical practicum; establishing protocols providing two-way communication feedback notification from all participating sites; establishing protocols to clarify quality of transmission data; establishing protocols for rapid recovery of real-time two-way communication following failure of transmission data; and establishing protocol(s) for real-time two-way audiovisual connectivity immediately prior to scheduled remote access practicum.

Data transmissions may include, for example, any data from remote physical assessment devices such as digital stethoscopes, digital opthalmoscopes, etc. and/or remote monitoring devices such as EKG monitors, arterial lines readings/waveforms, Swan Ganz catheter pressure readings and/or data, etc. One example as depicted in FIG. 1 may include the use of two cameras and videoconferencing equipment at the patient's bedside in the intensive care unit. One camera may be focused on the cardiac monitor which displays the heart rate and rhythm, arterial blood pressure, central venous pressure, oxygen saturation and respiratory rate. The other camera may be focused on the nurse taking care of the patient and explaining what is going on and what she/he is doing with the patient and why. The transmission of a dual image (i.e. monitor with live data readings plus nurse working and/or teaching at the patient's bedside) can occur via secure, encrypted internet connection to, for example, a group of forty students who are six-hundred miles away in a classroom at their school of nursing. The students can watch the monitor on one side of their screen while watching, listening, and/or interacting with the nurse preceptor on the other half of their screen. Students can participate in the same live, clinical experience together, and their faculty person is in the room at the school with the students, being able to explain and interpret the “action” that is occurring with the intensive care patient and the nurse preceptor.

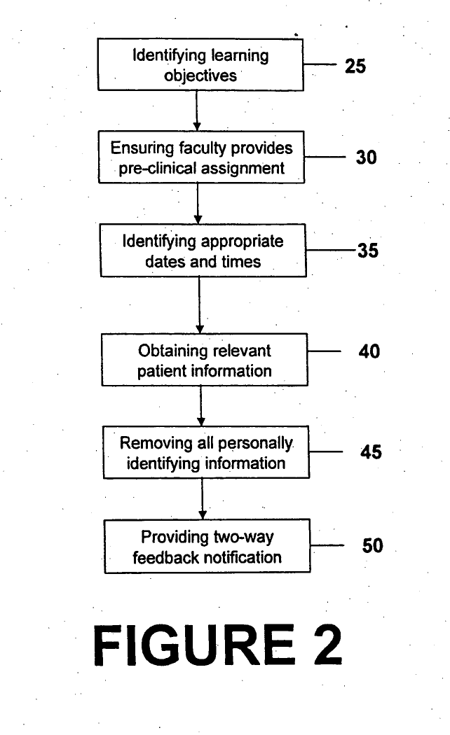

In FIG. 2, this exemplary method is illustrated therein. In the method of FIG. 2, the following steps are shown: identifying learning objectives of clinical experience and creating a tailored schedule based on these objectives 25; ensuring that the faculty provide students with an assignment to prepare for “virtual clinical” 30; identifying appropriate dates and times to satisfy clinical learning objectives 35; obtaining relevant clinical information about selected patient before scheduled remote learning experience 40; removing all personally identifying information to ensure anonymity and transmitting such information to students prior to the remote clinical practicum 45; and establishing protocols providing two-way communication feed back notification from all participating sites 50.

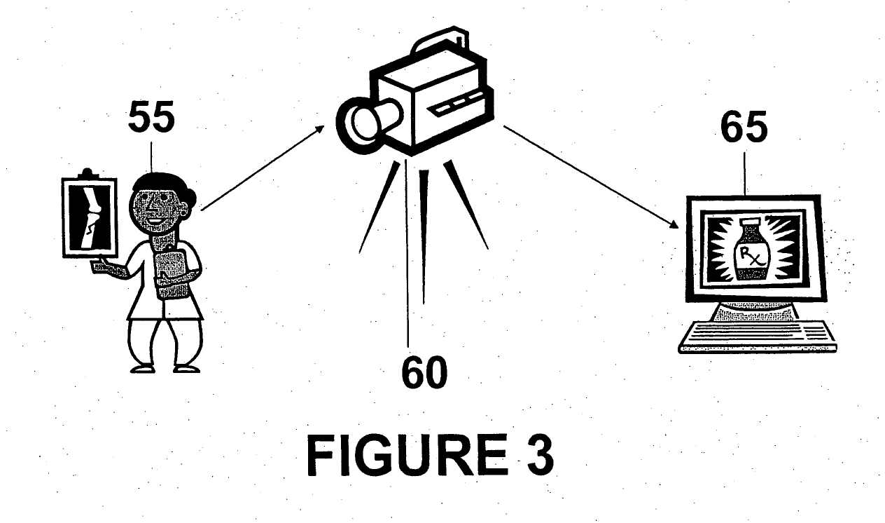

As shown in FIG. 3, it is contemplated that one example of the operational methods for implementing a virtual clinical practicum may include transmitted real-time two-way data that portrays subject content by presenting appropriate visual and physical assessment images, sounds and/or data. This is accomplished, for example, by means of commercially available mobile videoconferencing products, along with additional commercial cameras, may be pre-positioned in the patients' rooms. Data, audio, and/or video may, for example, be transmitted via high speed network connections (such as internet, T1 phone line, or intranet) to the receiving site(s) where the students are located. Cameras may be operated via remote controls and clinical events may be focused upon during the course of the virtual clinical experience without disturbing the actual patient care.

The following additional steps or functions, or subsets thereof, may be included: close-up image of individual's face when addressing students (for example, the remote preceptor, the patient, or the therapist); close-up image when individual explains complex concepts; close-up image when audio is not clear due to ambient noise, soft voice of speaker or accept of speaker; close-up image when emotional information is exchanged by speaker, for example, with the patient; intermediate-length image when two people are speaking or an activity is demonstrated; intermediate-length image when nurse is addressing patient; wide-length image of entire room when several individuals are speaking at the same time; wide-length image of entire room when an individual is moving around the room; wide-length image of entire room when individual(s) are demonstrating equipment or patient treatments; magnified image when individual is representing small objects or demonstrating small, detailed procedures; magnified image when observing small details of patient assessment; ensuring that the individual speaking is always within the image; placing the audiovisual image into “pause” mode during scheduled and/or unscheduled breaks; placing the audiovisual image into active mode before resuming the practicum; and/or transmitting remote digital monitoring equipment and/or data from the host clinical site to the student sites.

Planning and implementing the remote clinical practicum may include the following tasks or issues: establishing the agenda to meet the learners' learning objectives; meeting with and/or coaching the clinical preceptor to identify desired information to be provided during the course of the clinical to meet learner objectives; providing a manual to participating faculty so they understand their role in facilitating the student learning during the remote clinical education process experience; establishing an evaluation plan in advance to measure desired objectives; establishing protocol for clinical site host to identify all participants of the virtual clinical; establishing protocol for all guest participants to verify participation in virtual clinic; the clinical professional preceptor, known as a virtual clinical preceptor, presenting relevant patient background and history; remote clinical preceptor demonstrating activities during the course of providing patient care that complies with all student learning objectives; remote clinical preceptor providing an opportunity for interactive questions and comments from all participants; remote clinical preceptor facilitating interaction between the participating students and the patient as patient's medical condition allows and as appropriate; remote clinical preceptor conducts assessment using agreed upon and available remote monitoring and/or digital devices and transmits data to learners; remote clinical preceptor responding to comments and answering questions pertaining to student learning objectives; remote clinical preceptor announcing scheduled and/or unscheduled pauses and explaining when the virtual clinical practicum will resume; remote clinical preceptor announcing the resumption of the virtual clinical practicum; and/or clinical preceptor, learners and faculty participating in evaluations as determined prior to experience.

In FIG. 3, healthcare preceptors 55 talk with and demonstrate clinical healthcare to students. Cameras in the patient room transmit live clinical information and video feed 60 to students. Students at a remote site are able to hear and see clinical care 65.

Referring again to FIG. 3, it is contemplated that the following additional steps or functions, or subsets thereof, may be presented: close-up imaging of an individual's face when addressing students (for example, a remote preceptor, patient or therapist); close-up imaging when an individual explains complex concepts; close-up imaging when audio is not clear due to ambient noise, soft voice of speaker or accent of speaker; close-up imaging when emotional information is exchanged by speaker; intermediate length imaging when two people are speaking or an activity is demonstrated; intermediate length imaging when nurse is addressing patient; wide length imaging of entire room when several individuals are speaking at the same time; wide length imaging of entire room when an individual is moving around the room; wide length imaging of entire room when individual/individuals are demonstrating equipment or patient treatments; magnified imaging when individual is representing small objects or demonstrating small detailed procedures; magnified imaging when observing small details of patient assessment; ensuring that the individual speaking is always within the image; “pausing” the audiovisual image during scheduled and unscheduled breaks; activating the audiovisual image before resuming the practicum; and transmitting remote digital monitoring equipment and/or data from the host clinical site to the student sites.

It is contemplated that planning and implementing the remote clinical practicum may include the following tasks or issues: establishing the agenda to meet the students' learning objectives; meeting with and coaching clinical preceptor to identify desired information to be provided during the course of the clinical to meet student objectives; meet with and provide manuals to participating faculty so they understand their role in facilitating the student learning during the remote clinical education process experience; establishing an evaluation plan in advance to measure desired objectives; establishing protocol for the clinical site host to identify all participants of the virtual clinical; establishing protocol for all guest participants to verify participation in virtual clinic; presenting relevant patient background and history to virtual clinic students; demonstrating activities that comply with all student learning objectives; providing the opportunity for interactive questions and comments from all participants; facilitating interaction between the participating students and the patient, as patient's medical condition allows and as appropriate; conducting assessments using agreed upon and available remote monitors and digital devices and transmitting data to students; responding to comments and answering questions pertaining to student learning objectives; announcing scheduled and unscheduled pauses, as well as when the virtual clinical practicum will resume; announcing the resumption of the virtual clinical practicum; and participating in evaluations prior to virtual clinical experience.

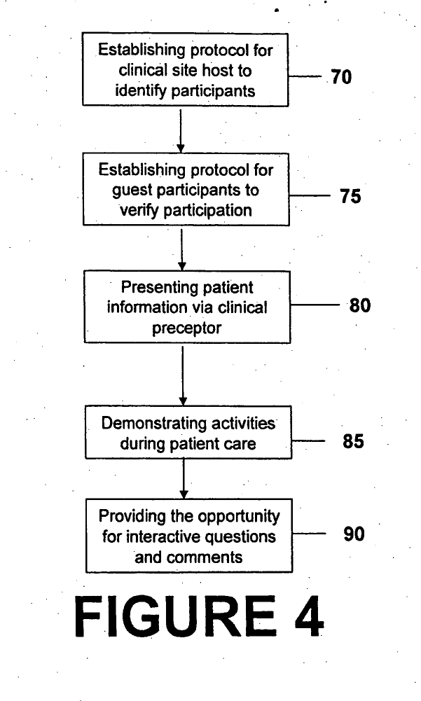

In FIG. 4, the method is illustrated in the following steps: establishing protocol for clinical site host to identify all participants of the virtual clinic 70; establishing protocol for all guest participants to verify participation in virtual clinic 75; presenting relevant patient background and history to virtual clinic students 80; demonstrating activities that comply with all student learning objectives 85; and providing the opportunity for interactive questions and comments from all participants 90.

At the conclusion of a typical session of the remote clinical learning experience, it is contemplated that the clinical preceptor may provide an overview of content presented during the virtual practicum. The preceptor may also provide an opportunity for all participants to make summary comments and ask questions, and respond to comments and answer questions. Additionally, post-session evaluation documentation may be completed by all students. The remote learning clinical session may be followed by a mirrored or follow-up simulation laboratory experience allowing students an opportunity to acquire hands-on skills required by learning objectives.

Although the invention has been particularly shown and described with reference to the various embodiments provided above, it will be understood by those skilled in the art that various changes in form and detail may be made to these various embodiments without departing from the spirit and scope of the invention.

What is claimed is:

1. A method for virtual clinical healthcare learning, the method comprising:
identifying a clinical learning objective of clinical experience and creating a tailored schedule for a remote clinical practicum at a clinical site based on said objective;
providing a learner with an assignment to prepare for virtual clinical;
identifying an appropriate date and time to satisfy a clinical learning objective;
obtaining relevant clinical information about a patient before a remote learning experience;
removing personally identifying information regarding a patient;
transmitting patient information to a learner prior to the remote clinical practicum; and
providing two-way communication from said participating clinical site to said learner.

2. The method of claim 1, further comprising:
clarifying quality of transmission data;
rapidly recovering real-time two-way communication following failure of transmission data; and
establishing real-time two-way audiovisual connectivity immediately prior to scheduled remote clinical practicum.

3. The method of claim 1, further comprising:
addressing the learner by one or more individuals selected from patient, nurse, student, therapist, faculty, programmed image and preceptor by real-time two-way communication;
providing a close-up image of an individual's face when said individual is addressing said learner;
providing an intermediate length image of a plurality of individuals when said plurality of individuals are speaking or an activity by a plurality of individuals is demonstrated;
providing an intermediate length image when an individual is addressing said patient; and
providing a wide length image of an entire room when a predetermined number of individuals are speaking at the same time or when said individuals are demonstrating equipment or patient treatments.

4. The method of claim 3, further comprising:
providing a magnified image when an individual is representing small objects or demonstrating small detailed procedures or when said learner is directed to observe small details of patient assessment.

5. The method of claim 3, wherein the individual speaking is always within the image.

6. The method of claim 1, further comprising:
transmitting via remote digital monitoring equipment from multiple host clinical sites to multiple student sites.

7. A method for providing virtual clinical education comprising:
identifying all participants of a virtual clinic;
verifying participation in said virtual clinic;
presenting patient information via a clinical preceptor;
demonstrating activities during the course of providing patient care;
providing a system for interactive questions and comments from all participants of said virtual clinic.

8. The method of claim 7, further comprising:
conducting clinical assessment using remote monitoring devices and transmitting voice, video and digital data to students to meet a tailored program fulfilling pre-established learning objectives.

9. The method of claim 7, further comprising:
providing a system enabling participants to respond to comments and answer questions;
training students, faculty, or healthcare preceptors at a patient site regarding how to participate in a virtual clinical experience;
evaluating the virtual clinical experience and providing iterative feedback; and
assessing the learning of critical thinking capability and critical decision making skills by said students.

10. The method of claim 1, further comprising:
providing a mobile videoconferencing system connecting a patient and a clinical site;
pre-positioning cameras in a patient room and in a clinical site;
providing data transmission via high speed network connections; and
operating cameras via remote control.

11. The method of claim 7, further comprising:
providing a mobile videoconferencing system;
pre-positioning cameras in a patient room;
providing data transmission via high speed network connections for a patient room to participants in said virtual clinic; and
operating cameras via remote control.

12. The method of claim 10 wherein operating cameras via remote control further comprises focusing cameras remotely during said virtual clinical learning.

13. The method of claim 1, further comprising:
providing patient care during virtual clinical learning.

14. The method of claim 7, further comprising:
providing patient care during virtual clinical learning.

15. A system for providing virtual clinical learning, the system comprising:
a clinical site;
a patient located at the clinical site;
a teacher, performing a clinical treatment on the patient, the teacher being recorded in real time; and
a remote site, the remote site receiving a transmission from the clinical site showing the teacher performing the clinical treatment.

16. The system of claim 15, further comprising:
at least one student, located at the remote site, capable of controlling a view of the clinical treatment.

17. The system of claim 16, wherein the at least one student interacts with the teacher using a two-way connection.

18. The system of claim 16, further comprising:
a remote diagnostic tool, the remote diagnostic tool being controllable by the teacher and by the student.
